(19) United States
(12) Patent Application Publication
(10) Pub. No.: US 2008/0152957 A1
(43) Pub. Date: Jun. 26, 2008

(54) Non-functional fuel cell for fuel cell stack

(75) Inventors: Ronald L. James, North Chill, NY (US); Ivan D. Chapman, Victor, NY (US); Steven J. Spencer, Rochester, NY (US); Sitima R. Fowler, Fairport, NY (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM Global Technology Operations, Inc., Detroit, MI (US)

(21) Appl. No.: 11/643,178

(22) Filed: Dec. 21, 2006

(51) Int. Cl. H01M 8/02; B05D 3/00

(52) U.S. Cl. 429/12; 427/115

(57) ABSTRACT

A non-functional fuel cell for a fuel cell stack includes a shim disposed between gas diffusion media, a bipolar plate at one end, and either a bipolar plate or a unipolar plate at the other end. The shim of the non-functional cell replaces the membrane electrode assembly (MEA) in a normal fuel cell located in the middle or the end of the fuel cell stack. The shim is coated with electrically conductive, corrosion-resistant protective coating. The shim may be cleaned prior to applying the protective coating to remove an oxide layer from the surface of the shim. The non-functional fuel cell may be included in the initial design of the fuel cell stack, or may be used to replace one or more damaged or inoperative fuel cells to increase the overall performance of the fuel cell stack.

### FIELD OF THE INVENTION

The present invention relates to a fuel cell stack, and in particular, to a non-functional fuel cell for a fuel cell stack.

### BACKGROUND OF THE INVENTION

Fuel cells are being developed as a power source for many applications including vehicular applications. One such fuel cell is the proton exchange membrane or PEM fuel cell. PEM fuel cells are well known in the art and include in each cell thereof a membrane electrode assembly or MEA. The MEA is a thin, proton-conductive, polymeric, membrane-electrolyte having an anode electrode face formed on one side thereof and a cathode electrode face formed on the opposite side thereof. In general, the membrane-electrolyte is made from ion exchange resins, and typically comprises a perfluorinated sulfonic acid polymer such as NAFION™ available from the E.I. DuPont de Nemeours & Co. The anode and cathode faces, on the other hand, typically comprise finely divided carbon particles, very finely divided catalytic particles supported on the internal and external surfaces of the carbon particles, and proton conductive particles such as NAFION™ intermingled with the catalytic and carbon particles; or catalytic particles, without carbon, dispersed throughout a polytetrafluoroethylene (PTFE) binder.

Multi-cell PEM fuel cells comprise a plurality of the MEAs stacked together in electrical series and separated one from the next by a gas-impermeable, electrically-conductive current collector known as a bipolar separator plate or a bipolar plate (BPP). Such multi-cell fuel cells are known as fuel cell stacks. The bipolar plate has two working faces, one confronting the anode of one cell and the other confronting the cathode on the next adjacent cell in the stack, and electrically conducts current between the adjacent cells. A unipolar plate (UPP) or unipolar separator plate has only one working face confronting the anode or the cathode of one cell, depending on which end of the fuel cell stack the unipolar plate is located. Current collectors at the ends of the stack contact only the end cells and are known as end plates. The separator plate contains a flow field that distributes the gaseous reactants (e.g. H₂ and O₂/air) over the surfaces of the anode and the cathode. These flow fields generally include a plurality of lands which contact the primary current collector and define therebetween a plurality of flow channels through which the gaseous reactants flow between a supply header and an exhaust header located at opposite ends of the flow channels.

There are many differences between the end cells and the other “normal” fuel cells in the fuel cell stack. One difference is that the ‘normal’ cells are sandwiched between two bipolar plates (BPPs), whereas the end cells are sandwiched between a BPP and a unipolar plate (UPP). Another difference is that the BPPs have an anode flow field on one side and a cathode flow field on the other side, whereas UPPs have only an anode or a cathode flow field, depending on the end of the fuel cell stack. This difference has several consequences. One consequence is that BPPs and UPPs are manufactured differently and it is difficult to achieve uniform flow distribution between the ‘normal’ fuel cells and the end cells. The flow distribution is commonly controlled by plate restriction. A plate with a higher restriction will get less flow than an average cell in the fuel cell stack. Another consequence is that UPPs are supporting only one-half of the reaction than BPPs. As a result, UPPs, in theory, should only have to remove one-half of the heat as compared to BPPs.

Another difference between the end cells and the other “normal” cells in the fuel cell stack is that the thermal loads from fuel cell to fuel cell are better understood in the middle fuel cells than in end cells of the fuel cell stack. An additional complication is that UPPs are not joined to a neighboring fuel cell, but rather are joined to a current collector plate. Typically, the non-reactive side of the UPPs has some type of conductive spacer or shim to achieve uniform contact between the UPP and the current collector plate. This interface makes predicting the thermal load on the UPP challenging for the following reasons:
a. The current collector plate is attached to the end unit with a large thermal mass. At start up, the middle fuel cells will come up to temperature much more quickly than the end cells because end cells are connected to a large heat sink. In hot idle conditions, the end cells will remain hot longer than the middle fuel cells.
b. The interface between the current collector plate and the UPP can have higher contact resistance than in other cells, which can lead to excessive heat generation at high current density operating conditions. This is due to both the contact resistance and the current distribution.
   i. The current collector plate is typically a tin or gold coated copper plate. These coatings corrode or delaminate with time, often caused by coolant leaking into the contact region. Regardless of the cause, the effect is increased resistance in specific areas of the plate. This leads to non-uniform current distributions, which can affect not only the end cells, but also neighboring fuel cells in the fuel cell stack.
   ii. Any increase in resistance at this interface, either local from non-uniform current distribution, or bulk increase caused by uniformly higher contact resistance, will cause additional waste heat on the non-reacting side of the UPP.
c. The thermal interface on end cells can also dramatically influence the water management properties of end cells. This is especially true during transients. End cells will remain colder than the rest of the fuel cell stack during start up. As a result, end cells are prone to flooding.

In addition to the thermal management problems, another difference between the end cells and the other “normal” cells in the fuel cell stack is that the end cells are more susceptible to flooding as a result of shutdown and start up. Even if the end cell is brought up to temperature at the same rate as the rest of the fuel cell stack during a start up procedure, there exists a potential for flooding just due to the cell location. Upon shut down, the entire fuel cell stack will cool down. Condensation forms and liquid water often pools in the end cells. At start up, this liquid water is difficult to remove and the end cells will often show lower performance. Thus, it would be desirable to provide an end cell that provides good electrical performance, while managing thermal mismatches and water management issues, especially during transient operating conditions.

### SUMMARY OF THE INVENTION

According to the invention, there is provided a fuel cell stack comprising a plurality of fuel cells including a membrane-electrode-assembly disposed between a gas diffusion media and a bipolar plate at each end thereof; an end fuel cell including the membrane-electrode-assembly disposed between the gas diffusion media, the bipolar plate at one end thereof, and a unipolar plate at the other end thereof; and a non-functional fuel cell including a shim disposed between the gas diffusion media, the bipolar plate at one end thereof, and one of the bipolar plate and the unipolar plate at the other end thereof.

In another embodiment of the invention, a non-functional fuel cell for a fuel cell stack comprises a shim disposed between gas diffusion media, a bipolar plate at one end thereof, and one of the bipolar plate and the unipolar plate at the other end thereof.

A method of manufacturing a non-functional fuel cell for a fuel cell stack comprises the steps of:

removing an oxide layer from said shim; and

applying an electrically conductive, corrosion-resistant protective coating on said shim to protect said shim from the corrosive environment of said fuel cell stack.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic perspective view of a PEM fuel cell stack according to an embodiment of the invention;

FIG. 2 is an exploded, cross-sectional view of the PEM fuel cell stack taken along line 2-2 of FIG. 1;

FIG. 3 is a schematic side view of a shim used in a non-functional fuel cell according to an embodiment of the invention;

FIGS. 4 and 5 are cross-sectional views of the shim taken along line 4-4 of FIG. 3;

FIG. 6 is a graph of a voltage drop test that compares the voltage drop as a function of current for a dummy fuel cell with GDM only and a non-functional fuel cell with different shims of the invention;

FIG. 7 is a graph of the stack performance when the non-functional fuel cell was inserted into end cells of a fuel cell stack; and

FIG. 8 is a chart of HFR when the non-functional fuel cell was inserted into end cells of the fuel cell stack.

### DETAILED DESCRIPTION OF THE PREFERRED EMBODIMENTS

The following description of the preferred embodiment(s) is merely exemplary in nature and is in no way intended to limit the invention, its application, or uses.

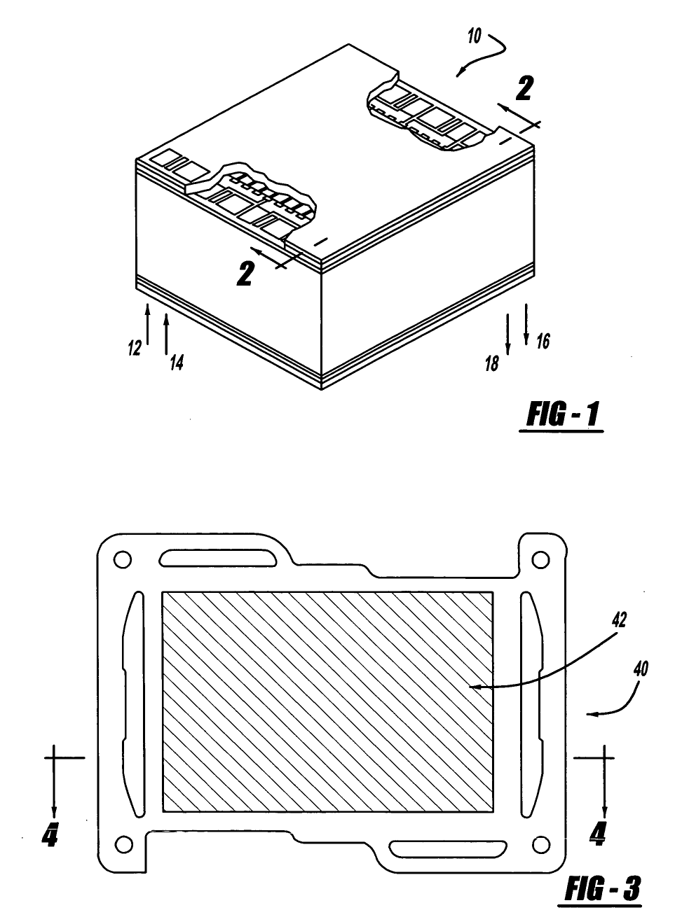

An exemplary PEM fuel cell stack is generally shown at 10 in FIG. 1. In general, hydrogen (or reformate) 12 and air 14 are delivered to the fuel cell stack 10 in a manner known in the art, and oxygen depleted air 16 and hydrogen effluent 18 are exhausted from the fuel cell stack 10.

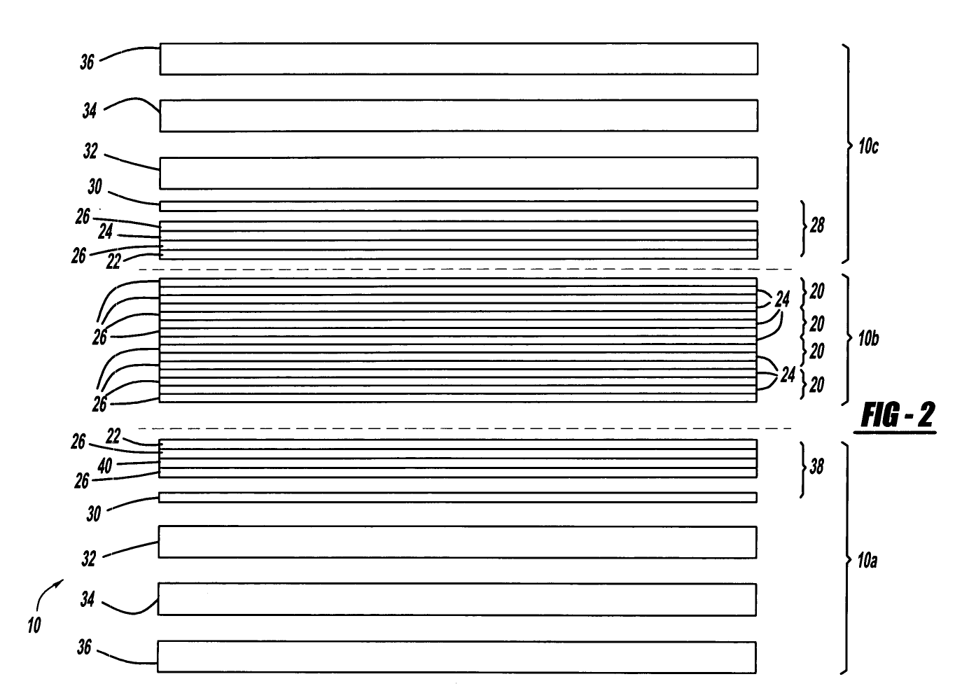

Referring now to FIG. 2, the fuel cell stack 10 includes a middle portion 10b that includes a plurality of fuel cells 20. Each fuel cell 20 includes a membrane-electrode-assembly (MEA) 24 disposed between a gas permeable carbon/graphite diffusion media (GDM) 26 that are sandwiched between a bipolar plate 22 at each end thereof. The GDM 26 presses against the electrode faces of the MEA 20. As is known in the art, each MEA 24 may comprise, for example, a membrane in the form of a thin proton transmissive non-electrically conductive solid polymer electrolyte, a seal or gasket member positioned against the lower and upper faces of the membrane, an anode catalyst layer on the upper face of the membrane, and a cathode catalyst layer on the lower face of the membrane. As shown, the exemplary fuel cell stack 10 includes a total of four (4) fuel cells 20 in the middle portion 10b thereof.

In the illustrated embodiment, the fuel cell stack 10 includes a top or upper portion 10c that includes an end fuel cell, shown generally at 28. The end fuel cell 28 includes a MEA 24 disposed between GDMs 26 that are sandwiched between a bipolar plate 22 at one end thereof and a unipolar plate 30 at the other end thereof. Specifically, the bipolar plate 22 is disposed adjacent the GDM 26 of the uppermost fuel cell 20 in the middle portion 10b of the fuel cell stack 10. The top portion 10c also includes a terminal or collector plate 32 disposed adjacent the unipolar plate 30, an insulator plate 34 adjacent the terminal plate 32, and an end plate 36 adjacent the insulator plate 34 and forms the top of the fuel cell stack 10.

Similarly, the fuel cell stack 10 also includes a bottom or lower portion 10a that includes the terminal or collector plate 32 disposed adjacent the unipolar plate 30, the insulator plate 34 adjacent the terminal plate 32, and the end plate 36 adjacent the insulator plate 34 and forms the bottom of the fuel cell stack 10.

The bottom portion 10a also includes a non-functional end fuel cell, shown generally at 38, according to an embodiment of the invention. The non-functional end fuel cell 38 includes a shim 40 disposed between GDMs 26 and sandwiched between a bipolar plate 22 at one end thereof and a unipolar plate 30 at the other end thereof. Specifically, the bipolar plate 22 is disposed adjacent the GDM 26 of the lowermost fuel cell 20 in the middle portion 10b of the fuel cell stack 10. However, unlike the end fuel cell 28 that includes the MEA 24 disposed between the GDMs 26, the end fuel cell 38 includes the shim 40 disposed between the GDMs 26. Thus, the non-functional end fuel cell 38 of the invention is substantially identical to the end fuel cell 28, except that the MEA 24 in end fuel cell 28 is replaced with the shim 40.

It will be appreciated that the non-functional end fuel cell 38 can also be substantially identical to the fuel cell 20, except that the MEA 24 in the fuel cell 20 is replaced with the shim 40. Therefore, it will be appreciated that the invention is not limited by the location of the non-functional end fuel cell. For example, the MEA 24 of the fuel cell 20 can be replaced with the shim 40 so as to form a non-functional fuel cell in the middle portion 10b with bipolar plates 22 at each end thereof. In addition, the MEA 24 of the end fuel cell 28 can be replaced with the shim 40 so as to form a non-functional fuel cell in the top portion 10c with a bipolar plate 22 at one end thereof and a unipolar plate 30 at the other end thereof.

The replacement of the MEA 24 with the shim 40 in a functional fuel cell to produce a non-functional fuel cell may be due to several reasons. One such reason is that the fuel cell stack 10 is initially designed to include the non-functional fuel cell 38. It is possible that the non-functional fuel cell can be included in the design of the fuel cell stack 10 on a production basis. Another such reason is that one or more of the fuel cells 20, 28, 38 are in need of repair because of poor current distribution, GDM creep, stack interference, and the like. Replacing the MEA 24 with the shim 40 to convert a damaged or inoperative functional fuel cell to a non-functional cell may prevent scrapping the entire fuel cell stack when only a minor repair of one or more fuel cells is needed.

In an H₂—O₂/air PEM fuel cell environment, the bipolar plates 22 and other contact elements (e.g., end plates 36) are in constant contact with highly acidic solutions (pH 3-5) containing F⁻, SO₄⁻⁺, SO₃⁻, HSO₄⁻, CO₃⁻⁺, HCO₃⁻, and the like. Moreover, the cathode operates in a highly oxidizing environment, being polarized to a maximum of about +1 V, as compared to the normal hydrogen electrode, while being exposed to pressurized air. Finally, the anode is constantly exposed to super atmospheric hydrogen. Hence, contact elements made from metal must be resistant to acids, oxidation, and hydrogen embrittlement in the fuel cell environment. As few metals exist that meets this criteria, contact elements have often been fabricated from large pieces of graphite, which is corrosion-resistant, and electrically conductive in the PEM fuel cell environment. However, graphite is quite fragile, and quite porous, making it extremely difficult to make very thin gas impervious plates therefrom.

Typically, the shim 40 is made of metal material, such as aluminum and its alloys, stainless steel, and the like. Such metals are more conductive than graphite, and can be formed into very thin plates. Unfortunately, such light weight metals are susceptible to corrosion in the hostile PEM fuel cell environment, and contact elements made therefrom either dissolve (e.g., in the case of aluminum) that increases the internal resistance of the fuel cell and reduces its performance.

In the end fuel cell, for example, the carbon gas diffusion media (GDM) 26 interfaces with the MEA 24 and sandwiched between the unipolar plate (UPP) 30 and the bipolar plate (BPP) 22. However, in the non-functional fuel cell 38 of the invention, the GDM 26 interfaces with the shim 40 at a working face 42 at which current travels through the shim 40, as shown in FIG. 3. Because of possibility of oxidation of the metal material in the harsh PEM environment, the interface between the GDM 26 and the metal shim 40 requires a treatment to provide a low contact resistance. Otherwise, the presence of oxide at the interface of the GDM 26 and the shim 40 will generate excessive heat in the non-functional fuel cell 38.

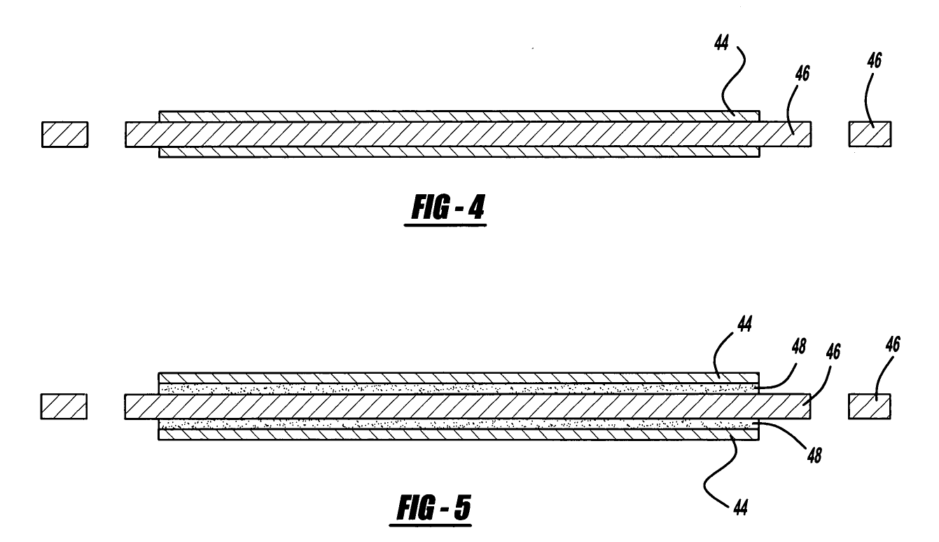

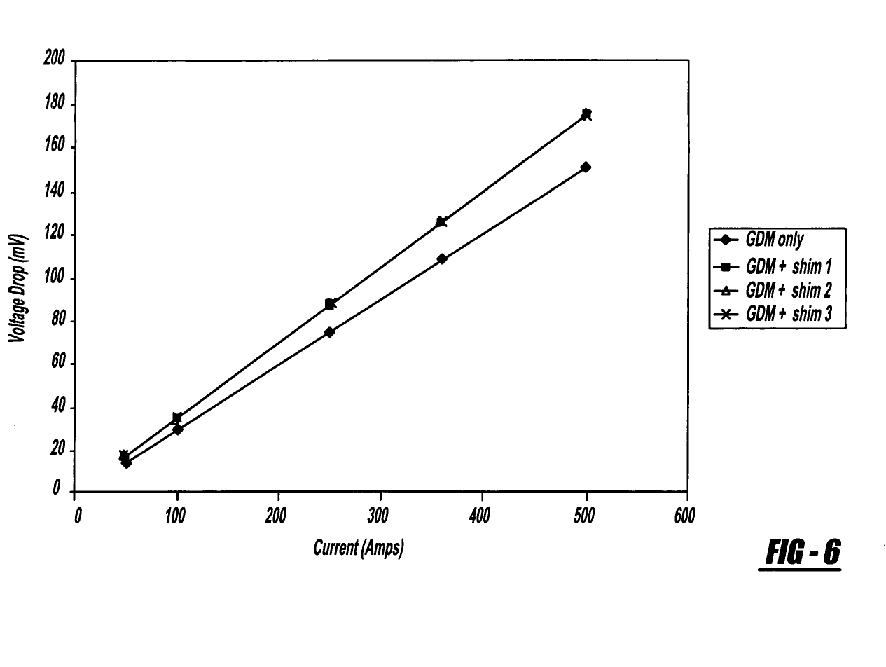

Referring now to FIGS. 4 and 5, a low contact resistance is achieved by coating the shim 40 of the non-functional fuel cell 38 with an electrically conductive, oxidation resistant, and acid-resistant protective coating material 44 to prevent excessive heat resulting from the oxidation of the shim 40. The thickness of the coating material 44 is approximately 0.020 mm per side. However, it is recommended that the thickness of the shim 40 and the compressed GDM 26 should be approximately the same thickness as the MEA 24 so that the non-functional fuel cell 38 is substantially identical in overall dimensions to the end fuel cell 28.

The coating material 44 has a resistivity less than about 50 ohm-cm, and comprises a plurality of oxidation-resistant, acid-insoluble, conductive particles (i.e. less than about 50 microns) dispersed throughout an acid-resistant, oxidation-resistant polymer matrix. Preferably, the conductive filler particles are selected from the group consisting of gold, platinum, graphite, carbon, nickel, conductive metal borides, nitrides and carbides (e.g. titanium nitride, titanium carbide, titanium diboride), titanium alloyed with chromium and/or nickel, palladium, niobium, rhodium, rare earth metals, and other noble metals. Most preferably, the particles will comprise carbon or graphite (i.e. hexagonally crystallized carbon). The particles comprise varying weight percentages of the coating depending on the density and conductivity of the particles (i.e., particles having a high conductivity and low density can be used in lower weight percentages). Coatings containing carbon/graphite will typically contain 25 percent by weight carbon/graphite particles. The polymer matrix comprises any water-insoluble polymer that can be formed into a thin adherent film and that can withstand the hostile oxidative and acidic environment of the fuel cell. Hence, such polymers, as epoxies, silicones, polyamide-imides, polyether-imides, polyphenols, fluro-elastomers (e.g., polyvinylidene flouride), polyesters, phenoxy-phenolics, epoxide-phenolics, acrylics, and urethanes, inter alia are seen to be useful with the present invention. Cross-linked polymers are preferred for producing impermeable coatings.

In one embodiment, the metal substrate 46 forming the shim 40 may comprise a corrosion-susceptible metal such as (1) aluminum which is dissolvable by the acids formed in the cell, or (2) titanium or stainless steel which are oxidized/passivated by the formation of oxide layers on their surfaces. In this embodiment, the conductive polymer coating material 44 is applied directly to the substrate metal and allowed to dry/cure thereon. According to another embodiment, the substrate metal forming the shim 40 comprises an acid soluble metal (e.g., Al) that is covered with an oxidizable metal (e.g., stainless steel) before the electrically conductive polymer coating material 44 is applied thereto.

The coating material 44 may be applied in a variety of ways, e.g., (1) electrophoretic deposition, (2) brushing, spraying or spreading, or (3) laminating. Electrophoretically deposited coatings are particularly advantageous because they can be quickly deposited in an automated process with little waste, and can be deposited substantially uniformly onto substrates having complex and recessed surfaces like those used to form the reactant flow fields on the working face(s) of the contact elements. Electrophoretic deposition is a well-known process useful to coat a variety of conductive substrates such as automobile and truck bodies. Electrophoretic deposition technology is discussed in a variety of publications including “Cathodic Electrodeposition”, Journal of Coatings Technology, Volume 54, No. 688, pages 35-44 (May 1982). Briefly, in electrophoretic deposition processes, a direct current is passed through a suspension of the conductive particles in an aqueous solution of a charged acid-soluble polymer. Under the influence of the applied current, the polymer migrates to, and precipitates upon, a conductive substrate of opposing charge, and carries with it the conductive particles. When cross-linkable polymers are used, the suspension also includes a catalyst for promoting the cross-linking. Cathodic and anodic electrophoretic processes are both known. Cathodically deposited coatings are preferred for fuel cell applications, and are deposited by a process wherein positively charged polymer is deposited onto a negatively charged substrate. Anodically deposited coatings are less desirable since they tend to dissolve some of the substrate metal and contaminate the coating therewith. In cathodic electrophoretic coating, the passage of electrical current causes the water to electrolyze forming hydroxyl ions at the cathode and establishing an alkaline diffusion layer contiguous therewith. The alkalinity of the diffusion layer is proportional to the cathode current density. Under the influence of the applied voltage, the positively charged polymer migrates to the cathode and into the alkaline diffusion layer where the hydroxyl ions react with the acid-solubilized polymer and cause the polymer to precipitate onto the cathodic substrate. The conductive filler particles become trapped in the precipitate and co-deposit onto the cathodic substrate. Cathodic epoxies, acrylics, urethanes and polyesters are useful with this method of depositing the coating as well as other polymers such as those disclosed in the “Cathodic Electrodeposition” publication (supra), and in Reuter et al. U.S. Pat. No. 5,728,283 and the references cited therein. Subsequent baking of the coated contact element cures and densities the coating.

The coating (FIG. 3) is first formed as a discrete film (e.g. by solvent casting, extrusion etc.), and then laminated onto the working surface 42 of the shim 40, for example, by hot rolling and the like. This technique will preferably be used to make laminated sheet stock from which the shim 40 is subsequently formed, for example, as by stamping and the like. In this embodiment, the discrete film will preferably contain a plasticizer to improve handling of the film and to provide a coating layer atop the substrate that is supple enough so that it can be readily shaped, (e.g. stamped) without tearing or disrupting the film when the contact element is formed as by stamping.

The electrically conductive polymer film is applied to the working face 42 of the metal substrate 46 by spraying, brushing or spreading (e.g. with a doctor blade). In this embodiment of the coating, a precursor of the coating material 44 is formed by dissolving the polymer in a suitable solvent, mixing the conductive filler particles with the dissolved polymer and applying it in the form of wet slurry atop the metal substrate 46. The wet coating is then dried (i.e. the solvent removed) and cured as needed (e.g., for thermosets). The conductive particles adhere to the metal substrate 46 by means of the solvent-free polymer. A preferred polymer useful with this embodiment comprises a polyamide-imide thermosetting polymer. The polyamide-imide is dissolved in a solvent comprising a mixture of N-methylpyrrolidone, propylene glycol and methyl ether acetate. To this solution is added about 21% to about 23% by weight of a mixture of graphite and carbon black particles wherein the graphite particles range in size from about 5 microns to about 20 microns and the carbon black particles range in size from about 0.5 micron to about 1.5 microns with the smaller carbon black particles serving to fill the voids between the larger graphite particles and thereby increase the conductivity of the coating compared to all-graphite coatings. The mix is applied to the substrate, dried and cured to provide 15-30 micron thick coatings (preferably about 17 microns) having a carbon-graphite content of about 38% by weight. It may be cured slowly at low temperatures (i.e. <400° F.), or more quickly in a two step process wherein the solvent is first removed by heating for ten minutes at about 300° F.-350° F. (i.e., dried) followed by higher temperature heating (500° F.-750° F.) for various times ranging from about ½ min to about 15 min (depending on the temperature used) to cure the polymer.

Some coatings may be pervious to the fuel cell's hostile environment. Previous coatings are used directly only on oxidizable metals (e.g., titanium or stainless steel) and not directly on metals that are susceptible to dissolution in the fuel cell environment, for example, aluminum. Pervious coatings could, however, be used on dissolvable metal substrates, for example, aluminum, that have first been coated or clad with an oxidizable/passivating metal layer, for example, titanium, stainless steel, and the like. When pervious coatings are used on an oxidizable/passivating substrate or coating, oxides will form at the sites (i.e., micropores) where the coating is pervious, but not at sites where the polymer engages the substrate metal. As a result, only a small portion of the surface is oxidized/passivated (i.e. at the micropores in the coating) resulting in very little increase in electrical resistance attributable to the oxide formation.

The electrically conductive polymer coating material 44 is applied to an acid-dissolvable substrate metal, for example, aluminum, which had previously been coated with a layer of oxidizable/passivating metal, such as stainless steel, and the like. In this regard, a barrier/protective layer 48 of a metal that forms a low resistance, passivating oxide film is deposited onto the metal substrate 46, and is covered with a coating of the conductive polymer coating material 44. Stainless steels rich in chromium (i.e., at least 16% by weight), nickel (i.e., at least 20% by weight), and molybdenum (i.e., at least 3% by weight) are seen to be excellent such barrier/protective layers 48 as they form a dense oxide layer at the sites of the micropores in the polymer coating which inhibits further corrosion, but which does not significantly increase the fuel cell's internal resistance. One such stainless steel for this purpose is commercially available from the Rolled Alloy Company as alloy Al-6×N, and contains 23±2% by weight chromium, 21±2% by weight nickel, and 6±2% by weight molybdenum. The barrier/protective stainless steel layer is preferably deposited onto the metal substrate 46 using conventional physical vapor deposition (PVD) techniques (e.g., sputtering), or chemical vapor deposition (CVD) techniques known to those skilled in these art. Alternatively, electrolessly deposited nickel-phosphorous alloys appear to have good potential as a substitute for the stainless steel in that they readily form a passivating film when exposed to the fuel cell environment which provides a barrier to further oxidation/corrosion of the underlying coating.

To insure adherence of the coating material 44 to the metal substrate 46, the surface of the metal substrate 46 to which the film is applied is (1) cleaned of all undesirable surface films (e.g., oil), (2) oxides are removed by acid etching, and (3), most preferably, roughened or abraded to roughen the surface for anchoring the film thereto. Fluroelastomers, such as polyvinyladiene difluoride and the like, are useful and may be used with conventional plasticizers, such as dibutyl phthalate and the like. The removal of oxides can be accomplished by the use of several processes. One such process is a cathodic cleaning process. The cathodic cleaning process lowers the resistance of the bond between the coating and shim. The cathodic cleaning process is only required in the working face 42 of the shim 40. However, it is desirable to coat the shim 40 on both sides, but the location of the coating is dependent upon the seal and header design on the interfacing bipolar plate (BPP) 22 and unipolar plate (UPP) 30.

In order to keep the same seal load as the MEA 24 and to protect the header areas of the shim 40 from corrosion, it is desirable to apply the coating to the entire outer surface area of the metal substrate 46 forming the shim 40. However, in some applications, it may be desirable not to coat under the seal regions. In either case, it is important to ensure that the shim 40 is cleaned in the current distribution area or working face 42. Depending on when the final cutting of the shim 40 occurs, cleaning fixtures may make it difficult to clean the entire surface area of the shim 40. The coating material 44 can still achieve a good bond in the non cleaned regions, but these regions with not be as conductive. The area of the coating where conductivity is most important is nominally the same as the working face 42 of the shim 40 that interfaces with the GDM 26.

To assess the added resistance of the shim 40, the non-functional end cell 38 was tested for voltage drop using a full scale single cell test fixture. The cell test fixture was first constructed with the shim 40 disposed between two pieces of GDM 26, the BPP 22, and the UPP 30. Using a power supply and a voltmeter, the voltage drop was measured at different currents. The test was repeated with different shims inserted between the two pieces of GDM 26, the BPP 22 and the UPP 30.

The results of the conductivity test showed only about a 24 mV drop from adding the extra interface layers of the shim at high current density, as shown in FIG. 6. In general, the results were very repeatable and the linear nature of the data indicates a valid test method for measuring resistance.

TABLE I
Voltage Drop from Terminal to Terminal (mV)

| | | | | | |
|---|---|---|---|---|---|
| Current (Amps) | 50 | 100 | 250 | 360 | 500 |
| Equivalent Current | 0.14 | 0.28 | 0.69 | 1.00 | 1.39 |
| Density (A/cm2) | | | | | |
| GDM only | 14.5 | 30 | 75.3 | 108.4 | 150.6 |
| GDM + shim 1 | 17.3 | 34.7 | 87.2 | 125.3 | 173.9 |
| GDM + shim 2 | 17.4 | 34.8 | 87.2 | 125.5 | 174.3 |
| GDM + shim 3 | 17.4 | 34.8 | 87.3 | 125.7 | 174.4 |

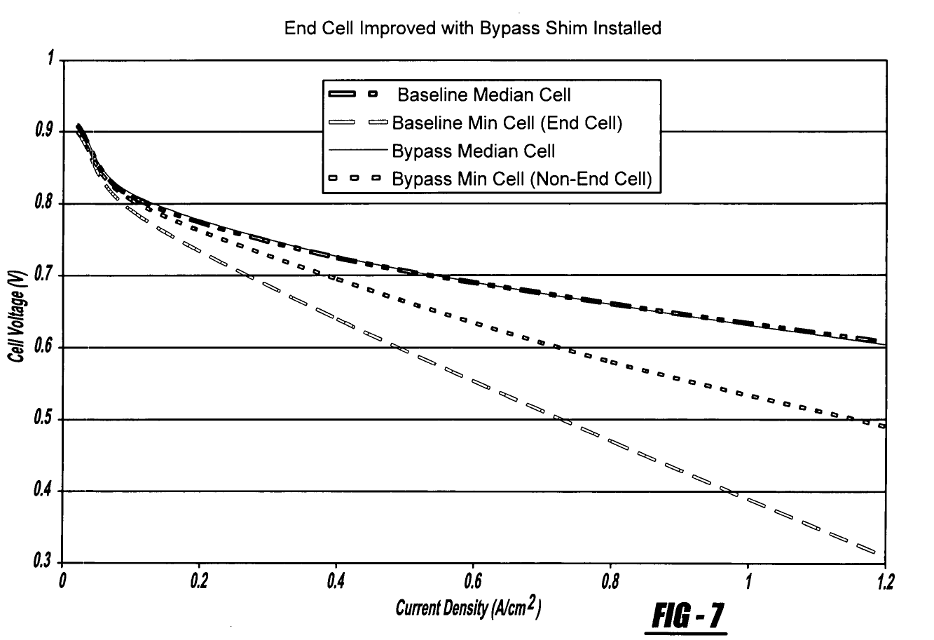

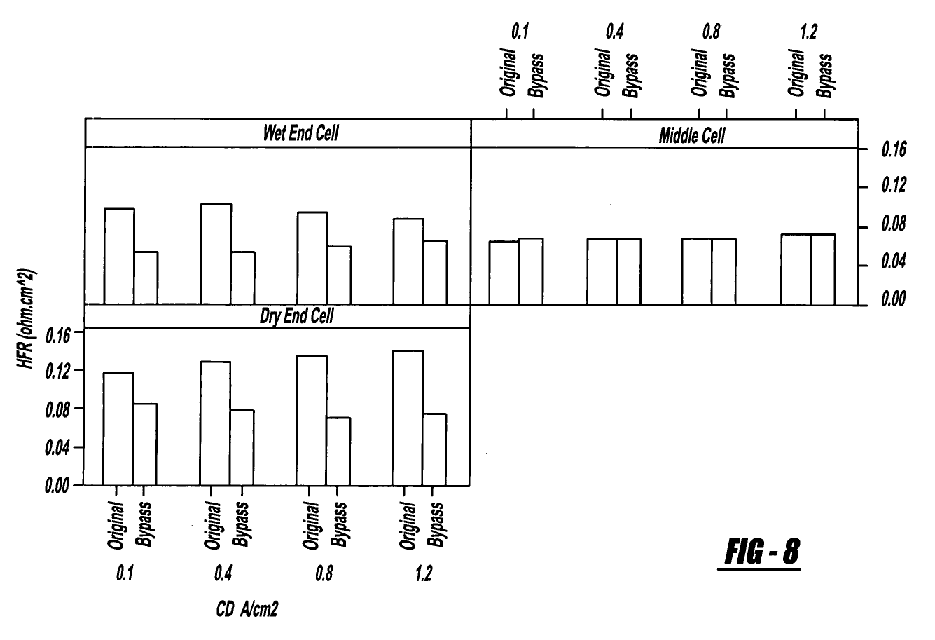

Following the voltage drop test, the non-functional cell 38 was inserted into the end fuel cells of a fuel cell stack. Prior to the insertion of the non-functional end cell 38, the fuel cell stack could not run the Fuel Cell Power Module (FCPM) base polarization curve without emergency stop due to low end cell performance. Prior to the switch, the current distribution of the end cells was so non-uniform that the problems propagated several cells into the stack. As shown in FIG. 7, the benefit of non-functional fuel cell (noted as “Bypass End Cell”) is realized.

In addition, the High Frequency Resistance (HFR) data from the fuel cell stack shows that the exceptional in-plane conductivity from the nonfunctional end cell reduces current distribution problems in neighboring cells. FIG. 8 illustrates that neighboring fuel cell resistance dramatically decreased after the non-functional fuel cell was inserted into the stack. The HFR measurements came back into line with the rest of the fuel cells indicating that the initially high HFR is caused by current distribution problems.

As described above, the shim can replace the MEA in a damaged or inoperative fuel cell in the fuel cell stack to form a non-functional fuel cell that provides acceptable current distribution. In addition, the non-functional fuel cell reduces current distribution problems in neighboring fuel cells and can be used in a fuel stack design that does not require replacement of a damaged or inoperative fuel cell.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fuel cell stack, comprising:
a plurality of fuel cells including a membrane-electrode-assembly disposed between gas diffusion media and a bipolar plate at each end thereof;
an end fuel cell including the membrane-electrode-assembly disposed between the gas diffusion media, the bipolar plate at one end thereof, and a unipolar plate at the other end thereof; and
a non-functional fuel cell including a shim disposed between the gas diffusion media, the bipolar plate at one end thereof, and one of the bipolar plate and the unipolar plate at the other end thereof.

2. A fuel cell stack according to claim 1, wherein the shim comprises a corrosion-susceptible metal substrate 46 and an electrically conductive, corrosion-resistant protective coating on a working face to protect said substrate from the corrosive environment of said fuel cell stack.

3. A fuel cell stack according to claim 2, wherein said protective coating comprises a mixture of electrically conductive particles dispersed throughout an oxidation-resistant and acid-resistant, water-insoluble polymeric matrix and having a resistivity greater than about 50 ohm-cm, said mixture comprising graphite particles having a first particle size and electrically conductive particles selected from the group consisting of gold, platinum, nickel, palladium, rhodium, niobium, titanium carbide, titanium nitride, titanium diboride, chromium-alloyed titanium, nickel-alloyed titanium, rare earth metals and carbon, said other particles having a second particle size less than said first particle size to enhance the packing density of said particles.

4. A fuel cell stack according to claim 2, wherein said protective coating is applied to the entire surface of said shim.

5. A fuel cell stack according to claim 2, wherein a layer of oxide is removed prior to applying said coating.

6. A fuel cell stack according to claim 1, further comprising a terminal plate disposed adjacent the unipolar plate, an insulator plate adjacent the terminal plate, and the end plate adjacent the insulator plate.

7. A non-functional fuel cell for a fuel cell stack comprising a shim disposed between gas diffusion media, a bipolar plate at one end thereof, and one of the bipolar plate and the unipolar plate at the other end thereof.

8. A fuel cell stack according to claim 7, wherein the shim comprises a corrosion-susceptible metal substrate 46 and an electrically conductive, corrosion-resistant protective coating on a working face to protect said substrate from the corrosive environment of said fuel cell stack.

9. A fuel cell stack according to claim 8, wherein said protective coating comprises a mixture of electrically conductive particles dispersed throughout an oxidation-resistant and acid-resistant, water-insoluble polymeric matrix and having a resistivity greater than about 50 ohm-cm, said mixture comprising graphite particles having a first particle size and electrically conductive particles selected from the group consisting of gold, platinum, nickel, palladium, rhodium, niobium, titanium carbide, titanium nitride, titanium diboride, chromium-alloyed titanium, nickel-alloyed titanium, rare earth metals and carbon, said other particles having a second particle size less than said first particle size to enhance the packing density of said particles.

10. A fuel cell stack according to claim 8, wherein said protective coating is applied to the entire surface of said metal substrate 46.

11. A fuel cell stack according to claim 8, wherein a layer of oxide is removed from said metal substrate 46 prior to applying said protective coating.

12. A method of manufacturing a non-functional fuel cell for a fuel cell stack, the non-functional fuel cell comprising a shim disposed between gas diffusion media, a bipolar plate at one end thereof, and one of the bipolar plate and the unipolar plate at the other end thereof, the method comprising the steps of:
removing an oxide layer from said shim; and
applying an electrically conductive, corrosion-resistant protective coating on said shim to protect said shim from the corrosive environment of said fuel cell stack.

13. A method according to claim 12, wherein said protective coating comprises a mixture of electrically conductive particles dispersed throughout an oxidation-resistant and acid-resistant, water-insoluble polymeric matrix and having a resistivity greater than about 50 ohm-cm, said mixture comprising graphite particles having a first particle size and electrically conductive particles selected from the group consisting of gold, platinum, nickel, palladium, rhodium, niobium, titanium carbide, titanium nitride, titanium diboride, chromium-alloyed titanium, nickel-alloyed titanium, rare earth metals and carbon, said other particles having a second particle size less than said first particle size to enhance the packing density of said particles.

14. A method according to claim 12, wherein said protective coating is applied to an entire surface of said shim.

15. A method according to claim 12, wherein said protective coating is applied to a working face of said shim.

16. A method according to claim 12, wherein the oxide layer is removed by using a cathodic cleaning process.
